(19) United States
(12) Patent Application Publication
(10) Pub. No.: US 2010/0162480 A1
(43) Pub. Date: Jul. 1, 2010

(54) FOOT WARMING UNIT FOR A SAUNA DEVICE

(76) Inventor: Xingjun QIAO, Shenzhen City (CN)

Correspondence Address: OSTROLENK FABER GERB & SOFFEN, 1180 AVENUE OF THE AMERICAS, NEW YORK, NY, 100368403, US

(21) Appl. No.: 12/345,913

(22) Filed: Dec. 30, 2008

(51) Int. Cl. A61H 33/06

(52) U.S. Cl. 4/524; 219/385

(57) ABSTRACT

A foot warming unit for a sauna device includes a plate-shaped heating unit provided in the sauna device, and a rigid foot support plate disposed over the heating unit. The foot support plate is made of a non-metallic heat conductive insulating material and has a bottom face in abutment with an upper face of the heating unit. Preferably, the heating unit has an insulating sheet and a resistive conductor formed in the insulating sheet. The foot warming unit is robust and safe and has a reduced size.

### BACKGROUND OF THE INVENTION

1. Field of the Invention

The invention relates to a sauna device, more particularly to a foot warming unit for a sauna device.

2. Description of the Related Art

At present, most of the sauna devices comprise a housing unit and a heating unit mounted in a lateral wall of the housing unit. Nevertheless, as hot air floats up, heat in the bottom part of the housing unit is insufficient to make a user's feet sweat and enhance his/her metabolism as desired.

For solving the aforementioned problem and enhancing the foot warming effect, as shown in FIG. 1, there is disclosed a sauna chamber or sauna cabinet 1 comprising a foot warming unit 2 provided in a bottom part of the sauna chamber or cabinet 1 made from wood. The foot warming unit 2 includes a heating unit 3 and a wooden foot support 4. The bottom part of the sauna chamber 1 has a wooden frame 5 surrounding a space that receives the heating unit 3, and the foot support 4 is mounted on top of the frame 5 and is spaced apart from the heating device 3. The foot support 4 has spaced apart longitudinal apertures 402 as a plurality of parallel wooden rods 401 are assembled in a spaced apart relationship to form the foot support 4. In use, the heating unit 3 heats the air within the frame 5, and the heated air flows upward through the apertures 402 in the foot support 4 and warms the user's feet.

However, the foot warming unit requires a large space in the bottom part of the sauna chamber 1, as the foot support 4 must be spaced above the heating unit 3 and as the heating unit 3 comprises several heating tubes. It is therefore necessary to increase the overall volume of the sauna chamber 1 in order to maintain the initial inner volume of the sauna chamber 1.

Moreover, the longitudinal apertures 402 of the foot support 4, which are necessary for dispersal of heat from the heating unit 3 to the user, can trap and hurt the user's toes, and are a source of cleaning troubles, for example objects may fall through the apertures 402.

Lastly, due to the apertures 402, the foot support 4 has poor strength and can be easily broken, causing thereby hazard and danger.

### SUMMARY OF THE INVENTION

Therefore, the main object of the present invention is to provide a foot warming unit for a sauna device that saves occupancy space and that enhances the foot warming effect.

According to one aspect of the invention, a foot warming unit for a sauna device comprises a plate-shaped heating unit provided in the sauna device and having an upper face, and a rigid foot support plate made of a non-metallic heat-conductive insulating material and disposed over the heating unit. The foot support plate has a bottom face in abutment with the upper face of the heating unit.

According to another aspect of the invention, a sauna device comprises a sauna chamber having a bottom wall, and a foot warming unit including a plate-shaped heating unit, and a rigid foot support plate. The plate-shaped heating unit is provided in the bottom wall and has an upper face. The foot support plate is made of a non-metallic heat-conductive insulating material and is disposed over the heating unit. The foot support plate has a bottom face in abutment with the upper face of the heating unit.

### BRIEF DESCRIPTION OF THE DRAWINGS

Other features and advantages of the present invention will become apparent in the following detailed description of the preferred embodiments with reference to the accompanying drawings, of which:

FIG. 1 is a sectional view of a conventional sauna device;

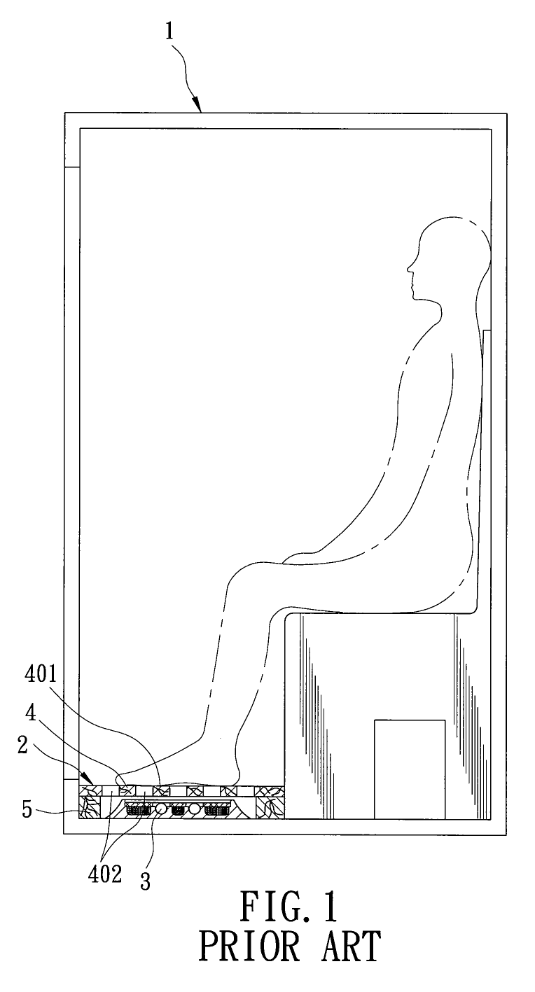

FIG. 2 is perspective view of a sauna device incorporating the foot warming unit according to the present invention;

FIG. 3 is an exploded view of a preferred embodiment of the foot warming unit according to the present invention; and

FIG. 4 is a sectional view of the preferred embodiment shown in FIG. 3.

### DETAILED DESCRIPTION OF THE PREFERRED EMBODIMENTS

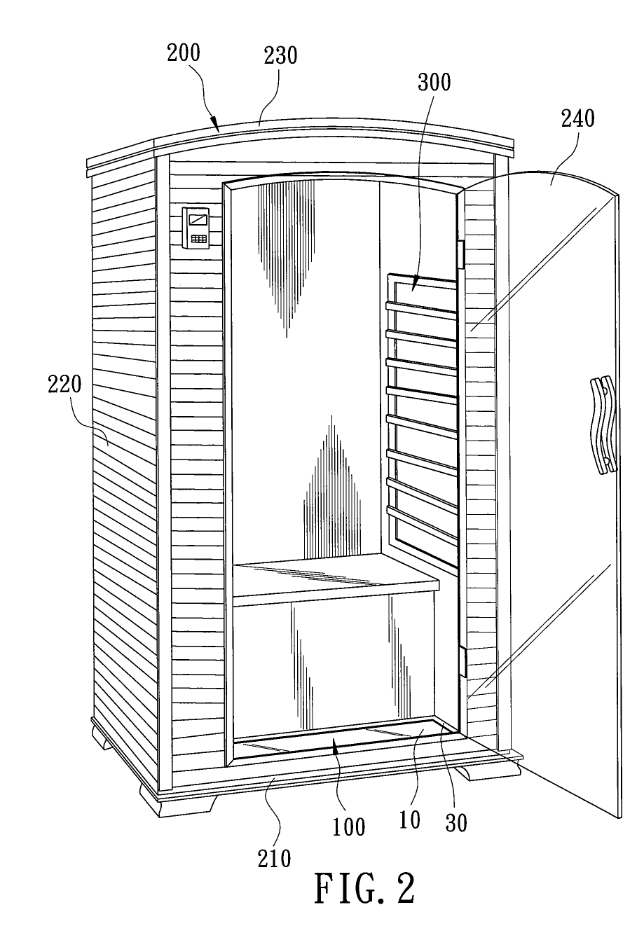

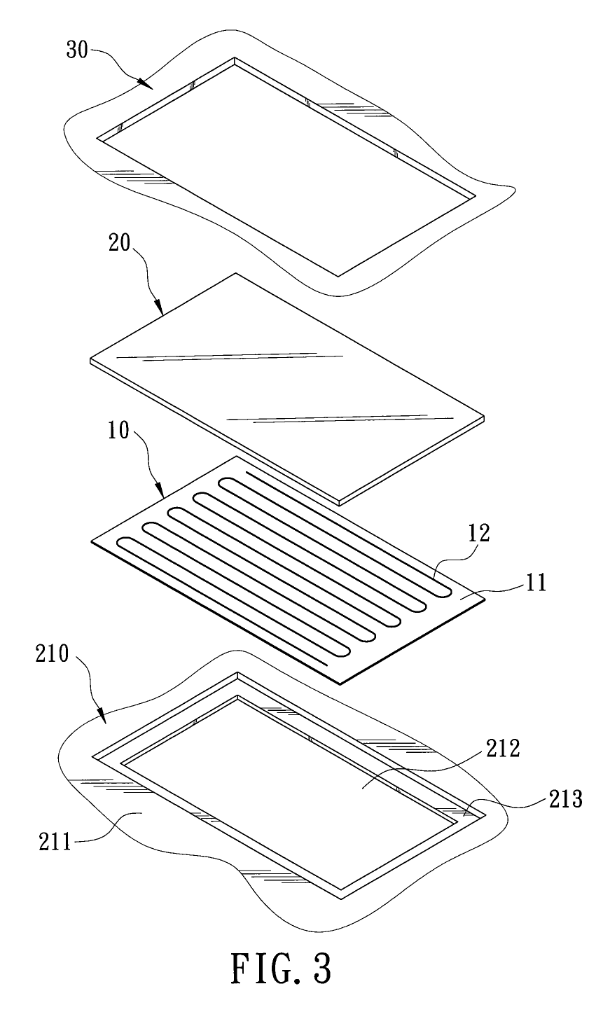

Referring to FIGS. 2 to 4, there is shown a sauna device incorporating a foot warming unit 100 according to the present invention. The sauna device includes a sauna chamber 200 and a heater 300. The sauna chamber 200 comprises a bottom wall 210, a top wall 230, and a surrounding lateral wall 220 interconnecting the bottom and top walls 210, 230. The lateral wall 220 is provided with a door 240 at a front side of the sauna chamber 200. The heater 300 is disposed in opposite sides of the lateral wall 220. The bottom wall 210 of the sauna chamber 200 has a framing section 211 surrounding a recess 212.

The foot warming unit 100 comprises a plate-shaped heating unit 10, and a rigid foot support plate 20 both of which are provided in the recess 212 and are surrounded by the framing section 211. The foot support plate 20 is disposed over the heating unit 10 and is made of a non-metallic heat-conductive insulating material, such as ceramic, or glass. A frame member 30 is disposed on the foot support plate 20.

According to a preferred embodiment of the invention, the foot support plate 20 is made of high strength glass, such as tempered glass or safety glass, and is free of openings. The plate-shaped heating unit 10 includes an insulating sheet 11, such as a thin plastic sheet, and a resistive conductor circuit 12 formed in the insulating sheet 11 and connectable to an electric source (not shown) through wires (not shown). The insulating sheet 11 has an upper face in abutment with a bottom face of the foot support plate 20.

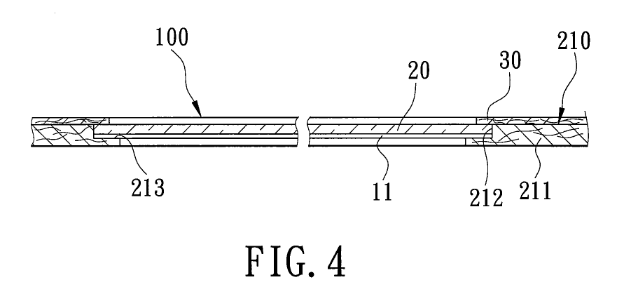

The framing section 211 of the bottom wall 210 has a shoulder face 213. The lateral peripheries of the foot support plate 20 and the insulating sheet 11 are fitted snugly in the recess 212 and are seated on the shoulder face 213 as best shown in FIG. 4. The frame member 30 is mounted to the framing section 211 above the foot support plate 20, and fixes the lateral peripheries of the foot support plate 20 and the insulating sheet 11 to the framing section 211.

Alternatively, the bottom wall 210 of the sauna chamber 200 is not recessed, and the foot warming unit 100 is disposed over the surface of the bottom wall 210.

The aforesaid structure of the foot warming unit 100 enables a significant reduction in the overall thickness thereof. Occupancy space in the sauna chamber 200 can be saved effectively.

In use, the user can put his/her feet in direct contact with the foot support plate 20 which is heated directly by the heating unit 10. The foot support plate 20 warms the user's feet and enhances the overall heating of the user's body which in turn enhances circulation of blood.

Moreover, as the foot support plate 10 is made of the high strength glass and is free of openings, the surface thereof is smooth and even, thereby facilitating cleaning, and preventing the user's feet from being trapped and getting hurt. In addition, due to the use of the high strength glass, the foot warming unit 100 is relatively robust and safe in use.

According another preferred embodiment, the heating unit 10 further includes a sensor that detects the temperature of the heating unit 10 so as to adjust the temperature and that guarantees a safe use of the foot warming unit 100. For example, the power of the heating unit 10 is turned off when a predetermined maximum threshold, such as 60° C., is reached, and turned on when a predetermined minimum threshold, such as 45° C., is reached.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A foot warming unit for a sauna device, said foot warming unit comprises:
a plate-shaped heating unit provided in said sauna device and having an upper face; and
a rigid foot support plate made of a non-metallic heat-conductive insulating material and disposed over said heating unit, said foot support plate having a bottom face in abutment with said upper face of said heating unit.

2. The foot warming unit of claim 1, wherein said foot support plate is made of high strength glass.

3. The foot warming unit of claim 1, wherein said heating unit includes an insulating sheet in abutment with said foot support plate, and a resistive conductor circuit formed in said insulating sheet.

4. The foot warming unit of claim 3, further comprising a frame member to fix lateral peripheries of said insulating sheet and said foot support plate to the sauna device.

5. A sauna device comprising:
a sauna chamber having a bottom wall; and
a foot warming unit including a plate-shaped heating unit, and a rigid foot support plate;
said plate-shaped heating unit being provided in said bottom wall and having an upper face;
said foot support plate being made of a non-metallic heat-conductive insulating material and disposed over said heating unit, said foot support plate having a bottom face in abutment with said upper face of said heating unit.

6. The sauna device of claim 5, wherein said foot support plate is made of high strength glass.

7. The sauna device of claim 6, wherein said bottom wall has a framing section surrounding a recess, said foot support plate and said insulating sheet being fitted in said recess and surrounded by said framing section.

8. The sauna device of claim 5, wherein said heating unit includes an insulating sheet in abutment with said bottom face of said foot support plate, and a resistive conductor circuit formed in said insulating sheet.

9. The sauna device of claim 8, wherein said foot warming unit further includes a frame member disposed over said foot support plate and fixing lateral peripheries of said insulating sheet and said foot support plate to said bottom wall.
